(19) United States
(12) Patent Application Publication
(10) Pub. No.: US 2004/0062350 A1
(43) Pub. Date: Apr. 1, 2004

(54) Arrangement for determining the spectral reflectivity of a measurement object

(75) Inventors: Max Christian Schuermann, Luebbecke (DE); Thomas Missalla, Wismar (DE); Bernd Seher, Jena (DE)

Correspondence Address: Gerald H. Kiel, Esq., REED SMITH LLP, 599 Lexington Avenue, New York, NY, 10022-7650, US

(73) Assignee: JENOPTIK Mikrotechnik GmbH

(21) Appl. No.: 10/672,110

(22) Filed: Sep. 26, 2003

(30) Foreign Application Priority Data
Sep. 26, 2002 (DE) 102 45 840.5

(51) Int. Cl. G01N 23/20

(52) U.S. Cl. 378/70

(57) ABSTRACT

In an arrangement for determining the spectral reflectivity of a measurement object, the object of the invention is to provide a simpler and more compact measuring arrangement, to eliminate the removal of elements from the beam path for detecting the reference beam, which was formally necessary, and to avoid complex translational and rotational movements. Different beam areas proceeding from the radiation source serve as measurement beam and reference beam which are directed simultaneously to different spectrally dispersing areas of at least one dispersive element and to different receiver areas of at least one receiver in a spectrograph. Preferred measurement objects are surfaces which reflect in a spectrally-dependent manner for radiation in the extreme ultraviolet range (EUV), but application of the arrangement is not limited to this spectral region.

### CROSS-REFERENCE TO RELATED APPLICATIONS

This application claims priority of German Application No. 102 45 840.5, filed Sep. 26, 2002, the complete disclosure of which is hereby incorporated by reference.

### BACKGROUND OF THE INVENTION

a) Field of the Invention

The invention is directed to an arrangement for determining the spectral reflectivity of a measurement object with a radiation source for irradiating the measurement object and a spectrograph for spectral radiation detection.

b) Description of the Related Art

Without imposing a limitation on the spectral range to be measured by the arrangement, preferred measurement objects are surfaces reflecting in a spectrum-dependent manner for radiation in the extreme ultra violet range (EUV), which surfaces achieve reflectivities in a narrow spectral range due to their layer construction.

The fabrication process for optics of the kind mentioned above requires meaningful quality controls in order to ensure homogeneous reflection characteristics.

It is known to employ reflectometers to determine the spectral reflectivity R(λ, θ, x, y) of a measurement object; spectral reflectivity R(λ, θ, x, y) is a function of the wavelength λ, the angle of incidence θ, and the location x, y and is given as the quotient of the reflected beam intensity I (λ, θ, x, y) to the incident beam intensity I₀ (λ, θ, x, y).

A measuring arrangement of the kind mentioned above which is known, for example, from the generic DE 199 48 264 A1 and is based on the polychromatic approach provides a plasma for generating a bundled polychromatic beam by which the measurement object is irradiated over a broad band after collimating. Further, there are devices for spectral analysis of the reflected radiation and a multichannel detector for detecting the reflected radiation.

The procedure, which was already regarded as uneconomical in the reference cited above, of building a second, identical unit from a spectrally dispersing element and a detector for the reference measurement in order to detect the radiation coming from the plasma by a direct route is disadvantageous. The detection of the measurement beam and reference beam can only be carried out successively; the measurement object is removed from the beam path and the second unit must be accommodated spatially. No substantial improvement is brought about by the proposed alternative solution in which the unit comprising spectrally dispersing element and detector is positioned on a swiveling arm and rotated about an axis for the reference measurement, since the size and weight of the objects to be moved lead to considerable problems. This is made still more difficult in that the movement referred to as rotation about an axis is of a rather complex nature because it is composed of a translation and a rotation.

### OBJECT AND SUMMARY OF THE INVENTION

Therefore, it is the primary object of the invention to provide a simpler and more compact measuring arrangement, to eliminate the removal of elements from the beam path for detecting the reference beam, which was formally necessary, and to avoid complex translational and rotational movements.

This object is met in an arrangement of the type mentioned in the beginning in that different beam areas proceeding from the radiation source serve as measurement beam and reference beam which are directed simultaneously to different spectrally dispersing areas of at least one dispersive element and to different receiver areas of at least one receiver in the spectrograph.

In a preferred construction, the different beam areas proceeding from a common emission region are selected in such a way that the measurement beam and the reference beam with a normal on the surface of the measurement object enclose identical angles with opposite signs, so that the measurement beam and the reference beam travel in parallel beam paths after the measurement beam is reflected at the surface of the measurement object.

Above all, a radiation source having isotropic emission characteristics at least in the different beam areas is advantageous. However, it is sufficient to identify an existing anisotropy in the different beam areas to be able to carry out corresponding corrections through calibration. A reflectometer in which defined emission characteristics of the utilized radiation source are made use of to carry out different detection simultaneously is realized in this way.

Further, the radiation source should be structurally small so that it can be positioned close to the specimen and an increased measuring accuracy can be achieved. Therefore, it is advantageous when the extension of the radiation source is limited such that the measurement beam and the reference beam do not intersect when the beam paths extend adjacent and parallel.

The requirements for the radiation source to be used are met to a great extent by x-ray tubes with a nearly punctiform emission region in which the different beam areas for the measurement beam and reference beam are selected from the uncollimated radiation of a large solid angle of emission.

In a particularly favorable construction of the invention, the different spectrally dispersing areas and the different receiver areas are provided as two areas located adjacent to one another on a dispersive element and on a receiver. But this does not mean that two separate adjacent dispersive elements and two separate adjacent receivers can not be provided in another construction.

The invention will be described more fully in the following with reference to the schematic drawings.

### BRIEF DESCRIPTION OF THE DRAWINGS

In the drawings:

FIG. 1 shows a schematic view of an arrangement according to the invention which uses the polychromatic approach for determining the spectral reflectivity of a measurement object;

FIG. 2 shows an arrangement for simultaneous determination of the spectral reflectivity with a plurality of incident angles;

FIG. 3 shows the arrangement of an x-ray tube with a rotating target; and

FIG. 4 shows a view of the movement directions and the tilting axis in an arrangement according to the invention for determining the spectral reflectivity of a measurement object as a function of wavelength, angle of incidence and measurement location.

### DESCRIPTION OF THE PREFERRED EMBODIMENTS

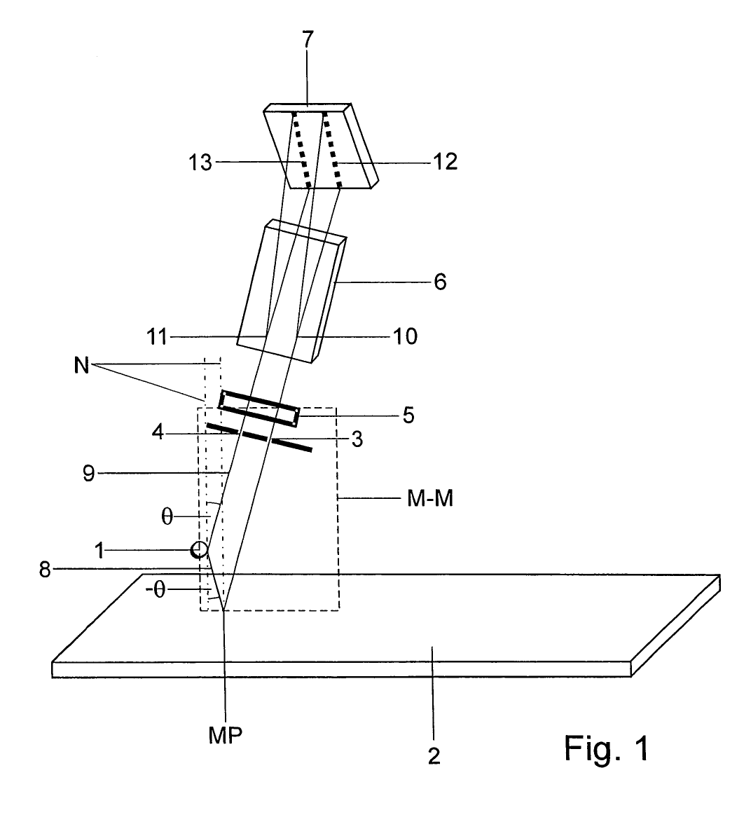

The arrangement shown in FIG. 1 contains an approximately punctiform radiation source 1 whose emission characteristics are ideally isotropic (I(θ)=const), but at least satisfy the condition I (θ)=I (−θ) with respect to a plane which extends parallel to the surface of a measurement object 2 that is displaceable in x-y direction and in which the radiation source 1 lies. Slits 3, 4 for beam-limiting are arranged in front of a spectrograph comprising an entrance slit 5, a dispersive element 6 and a receiver 7 with two-dimensional spatial resolution. While a reflection grating is used as a dispersive element 6 and a CCD chip is selected for the receiver 7 in the present embodiment example, transmission gratings or prisms and MCP/MSP with a phosphor screen or photographic film can also be used. The radiation source 1 is arranged close to the measurement object 2 in such a way that a measurement location MP on its surface, together with the radiation source 1 and the entrance slit 5, enclose a measurement plane M-M perpendicular to the surface of the measurement object 2. For reasons relating to geometry as well as intensity, as will be explained in the following, the proximity of the radiation source 1 to the surface of the measurement object 2 is important for keeping the resulting beam offset smaller than the surface to be detected.

Different beam areas proceeding from a common emission region of the radiation source have identical beam intensities I₀(λ) and serve as measurement beam and reference beam 8, 9. The beam areas are selected in such a way that the measurement beam and the reference beam 8, 9, with a normal N on the surface of the measurement object 2, enclose equal angles, but with opposite signs (−θ, θ).

Due to the geometry of the arrangement, the measurement beam and reference beam 8, 9, after reflection of the measurement beam 8 at the surface of the measurement object 2, extend parallel to one another in the measurement plane M-M, so that a spectrally resolved intensity measurement of the two beams is possible simultaneously with a spectrograph. With curved measurement objects, the parallelism of the reflected measurement beam and reference beam must be ensured by a suitable orientation of the measurement object insofar as permitted by the latter. The measurement beam and reference beam 8, 9 are limited by the two slits 3 and 4 before being directed via the entrance slit 5 to adjacent areas 10, 11 of the dispersive element 6. Areas 12, 13 located adjacent to one another on the receiver 7 are used to detect spectrally split radiation, so that after measurement, while taking into account the different path lengths to the radiation source 1, there is a measurement spectrum and a reference spectrum for I(λ) and I₀(λ) which gives the reflectivity of the surface in the measurement location MP as a function of the wavelength λ. The receiver 7 is advantageously constructed as a matrix with different parts of the matrix provided for different areas 12 and 13. Under certain circumstances, however, it is advantageous to use two separate receivers or two gratings as dispersive elements, but the recording of the two spectra is still carried out simultaneously as before.

The measurable wavelength area λ±αλ is given by the emission spectrum of the radiation source 1 and the spectral sensitivity of the spectrograph that is used. The reflectivity can be determined at various measurement locations MPi by an x-y translation of the measurement object 2; curved objects require a tilting of the measurement object 2 around two axes, in addition.

In principle, the spectral reflectivity can be measured by the arrangement according to the invention at different angles of incidence (0°<θ<90°) in that the spectrograph is oriented at angle θ to the normal N. Therefore, for every measurement, the reflectivity R(λ) is given for an angle of incidence θ.

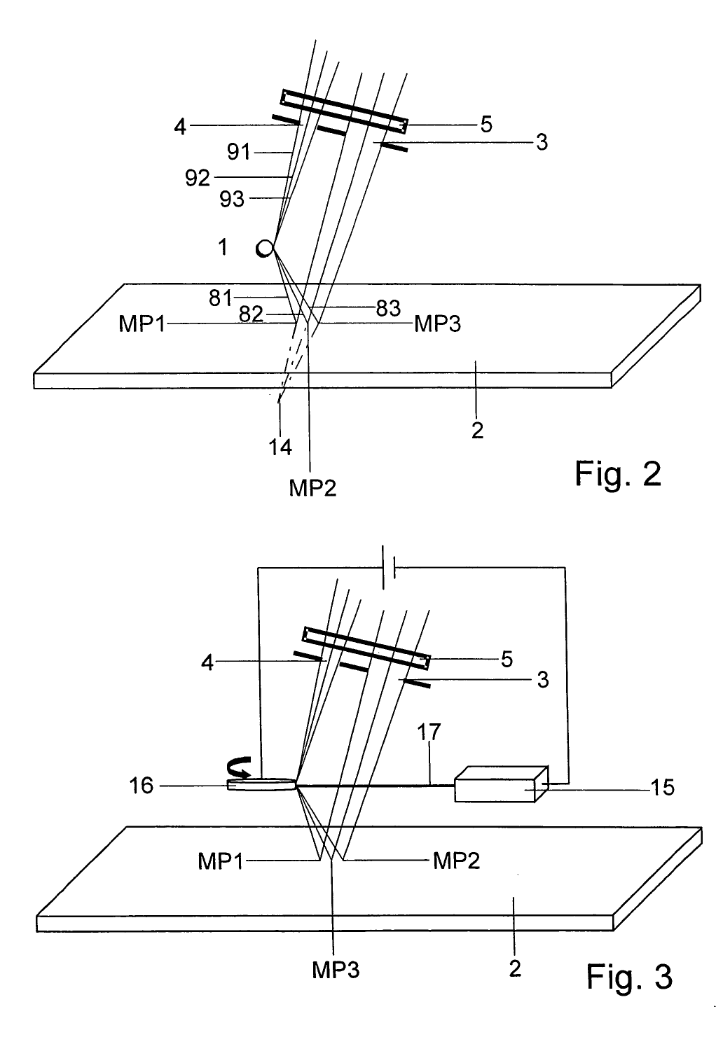

On the other hand, when an arrangement according to FIG. 2 is used and the spectrograph permits an angularly-resolved measurement, the spectral reflectivity R(λ) is obtained for several angles θᵢ by only one measurement.

The measurement beams 81, 82, 83 exiting from the radiation source 1 at various angles −θᵢ (in this case, i=1, 2, 3) impinge on the measurement object 2 at different measurement locations MP1 (x₁, y), MP2 (x₂, y) and MP3 (x₃, y) at incident angles θᵢ and are reflected at the same angles. When the slits 3, 4 for beam limiting are made larger, the reflected measurement beams 81, 82 and 83 coming from the virtual radiation source 14 are detected simultaneously in the spectrograph in an incident angle range of θ±Δθ. The reference beams 91, 92 and 93 exiting from the radiation source 1 at angle θᵢ can be detected in an analogous manner. In case of an isotropic radiation source, it is sufficient to measure a reference beam. Taking into account the beam path lengths, the spectral radiation intensities I(λ,θᵢ) and I₀(λ, θᵢ) which give the reflectivity R_{θ}(λ, θᵢ) in the incident angle range θ±Δθ as a function of wavelength λ can be determined. However, the reflectivity R_{θ}(λ, θᵢ) for different angles of incidence θᵢ is assigned to the different measurement locations MP1 (x₁, y), MP2 (x₂, y) and MP3 (x₃, y). When the reflectivity is determined as a function of wavelength, incident angle and location, the surface of the measurement object 2 must be scanned.

The size of the incident angle range θ±Δθ to be detected depends on the characteristics of the spectrograph that is used; the angle ranges to be detected are adjusted by the width of the slits for beam limiting 3, 4 in order to avoid mixing the measuring spectra and reference spectra on the receiver 7.

In principle, the incident angle range of a radiation source with isotropic emission characteristics with respect to radiation intensity I₀(λ) is twice as large as with a radiation source satisfying the condition I(θ)=I(−θ), since in the latter case half of the angular range is needed for receiving the reference spectra.

In the case of curved (and therefore imaging) measurement objects, the detectable angular ranges are subject to additional restrictions.

When the slit 4 for limiting the reference beams is sufficiently small, this results in a slit imaging of the radiation source 1 on the receiver 7, from which the size of the radiation source 1 can be determined. When slits 3 and 4 for beam limiting are removed from the beam paths and the measurement beams are blocked (e.g., also by moving the specimen out of the measuring area), the emission of the radiation source 1 can be examined in a part of the measurement half-plane, so that the essential characteristics of the radiation source 1 such as source size, isotropy of the emission, and the emission spectrum must be determined within the arrangement.

The radiation sources considered for the invention are, e.g., x-ray tubes in which the elementary process of emission is of an isotropic nature and any anisotropes result at most from the geometry of the target surface. Since the emission region of an x-ray tube of this kind is determined by the diameter of the incident electron beam, the latter can be formed in a correspondingly small and virtually punctiform manner.

Such x-ray tubes advantageously have, at least in some areas thereof, a continuous emission spectrum whose wavelength range can be realized by selecting a suitable target material. (Line radiators would reduce the measuring accuracy that could be achieved). The necessary vacuum operation is not a limitation because the beam must be guided in a vacuum in any case in the relevant wavelength range of 1 nm-100 nm, for example.

It is important that these sufficiently small radiation sources have standard solutions which have cooled or rotating targets and do not exert any damaging influences on the measurement object through particle emission, such as a plasma radiation source, so as to ensure positioning close to the measurement object which is necessary for the invention. Because of the large usable solid angle portion of the emission, a relatively weak light can also be compensated and measured with higher intensities.

According to FIG. 3, an advisable arrangement of an x-ray tube comprises an electron beam source 15 and a rotating target 16 which is a flat disk forming the anode. The rotation prevents excessive heating of the target 16 at the lateral location of incidence of the electron beam 17 emitted by the electron beam source 15. Of course, cooling can also be provided in addition. The required small relative distance is ensured in that the rotational plane of the target 16 is parallel to the surface of the measurement object 2.

It may be useful when the front face of the target disk is toroidal or tapered, for example, in order to generate a more focused bundling of the electron beam 17 so as to reduce the emission field. The shaping of the front face can also be used to reinforce the isotropy of the beam emission.

Arranging the electron beam source 15 outside the measurement plane M-M is also advantageous because the measurable angular area is not limited by partial blocking.

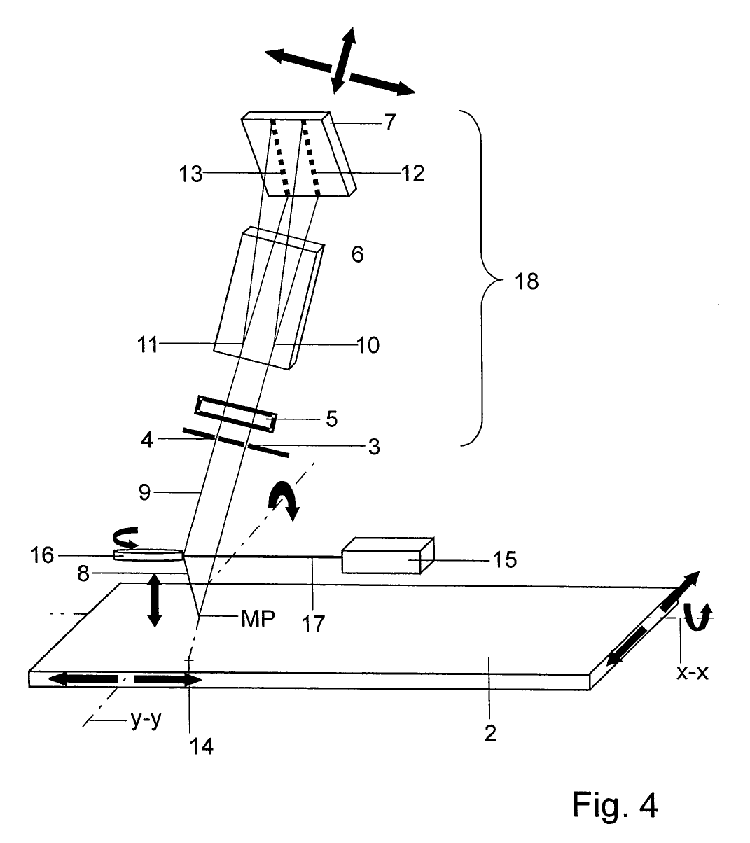

The arrangement shown in FIG. 4 is provided for measurements of reflectivity in a preferred wavelength range of 1 nm<1<100 nm, for incident angles of 0°<θ<90° and with reference to a measurement location Mᵢ on the surface of the measurement object 2.

For these tasks, the spectrograph 18 is arranged so as to be swivelable around the virtual radiation source 14 in order to be able to measure the different incident angle areas. The selected distance between the entrance slit 5 and the surface of the measurement object 2 is as small as possible in order to increase the light intensity. Since this minimum distance is dependent on the angle of incidence, the spectrograph 18 is held so as to be linearly displaceable in the manner indicated by the arrows. The x-ray tube with rotating target 16 serving as radiation source is arranged in a stationary manner, whereas, depending on measurement requirements, the measurement object 2, likewise indicated by arrows, is translationally or rotationally displaceable in the plane of the measurement object surface (with flat measurement objects) or in three spatial directions with tilting about two axes x-x and y-y (with measurement objects having a curved surface) which are perpendicular to one another.

The reflectivity of the surface of the measurement object 2 is calculated from the measured spectra while taking into account the geometry of the arrangement (positions, angles, distances . . . ). With radiation sources which are neither isotropic nor satisfy the condition I(θ)=I(−θ), it is necessary to carry out a calibration prior to measurement.

The spectrograph provided for the arrangement according to the invention is very important. Depending on the configuration of the spectrograph, possible dispersive elements for the preferred wavelength range are very thin transmission gratings or reflection gratings in grazing incidence; imaging reflection gratings are superior to transmission gratings by reason of greater light intensity and a higher resolution.

The arrangement of the spectrograph 18 resulting from these reflection gratings is rigid per se, i.e., the entrance slit 5, the dispersive element 6 and the receiver 7 are arranged in fixed positions relative to one another. Further, the reflection gratings, together with flat receivers, make possible the angularly resolving spectroscopy required for the above-described expansion of the reflectometer concept according to FIG. 2.

Thin, back-exposed CCD receivers can be used as flat receivers. They are very sensitive in the preferred wavelength range and can also be exposed for long times so that low intensities can also be measured. This type of receiver may possibly necessitate a beam interrupter in the beam path because the CCD receiver is usually read out in the slow scan mode, as it is called, in order to minimize the readout noise (typically of several seconds duration) and is further exposed during this period.

If the exposure time is long compared to the readout time, which depends above all on the intensity of the radiation source, a beam interrupter can be omitted, since the error due to the prolonged exposure during readout is sufficiently low.

While the foregoing description and drawings represent the present invention, it will be obvious to those skilled in the art that various changes may be made therein without departing from the true spirit and scope of the present invention.

What is claimed is:

1. An arrangement for determining the spectral reflectivity of a measurement object comprising:
a radiation source for irradiating the measurement object; and
a spectrograph for spectral radiation detection;
said radiation source having different beam areas proceeding therefrom serving as measurement beam and reference beam which are directed simultaneously to different spectrally dispersing areas of at least one dispersive element and to different receiver areas of at least one receiver in the spectrograph.

2. The arrangement according to claim 1, wherein the different beam areas proceeding from a common emission region are selected in such a way that the measurement beam and the reference beam with a normal on the surface of the measurement object enclose identical angles with opposite signs, so that the measurement beam and the reference beam travel in parallel beam paths after the measurement beam is reflected at the surface of the measurement object.

3. The arrangement according to claim 1, wherein the radiation source has known emission characteristics in the different beam areas.

4. The arrangement according to claim 1, wherein the radiation source has isotropic emission characteristics at least in the different beam areas.

5. The arrangement according to claim 3, wherein the extension of the radiation source is limited such that the measurement beam and the reference beam do not intersect when the beam paths extend adjacent and parallel.

6. The arrangement according to claim 5, wherein an x-ray tube whose uncollimated radiation is used for the measurement beam and reference beam serves as radiation source.

7. The arrangement according to claim 6, wherein the x-ray tube contains a rotating target disk as anode, whose plane of rotation extends parallel to the surface of the measurement object.

8. The arrangement according to claim 7, wherein the target disk is constructed so as to be tapered at its front face for reducing the emission region.

9. The arrangement according to claim 1, wherein the different spectrally dispersing areas and the different receiver areas are provided as two areas located adjacent to one another on a dispersive element and on a receiver.

10. The arrangement according to claim 1, wherein the different spectrally dispersing areas and the different receiver areas are provided as two separate adjacent dispersive elements and two separate adjacent receivers.
